(19) United States
(12) Patent Application Publication
(10) Pub. No.: US 2008/0273482 A1
(43) Pub. Date: Nov. 6, 2008

(54) UPLINK ACCESS METHOD FOR RECEIVING A POINT-TO-MULTIPOINT SERVICE

(75) Inventors: Young-Dae LEE, Gyeonggi-Do (KR); Sung-Duck CHUN, Gyeonggi-Do (KR); Sung-Jun PARK, Gyeonggi-Do (KR); Seung-June YI, Gyeonggi-Do (KR)

Correspondence Address: LEE, HONG, DEGERMAN, KANG & SCHMADEKA, 660 S. FIGUEROA STREET, Suite 2300, LOS ANGELES, CA, 90017, US

(73) Assignee: LG Electronics Inc.

(21) Appl. No.: 12/113,826

(22) Filed: May 1, 2008

Related U.S. Application Data
(60) Provisional application No. 60/915,666, filed on May 2, 2007.

(30) Foreign Application Priority Data
Apr. 24, 2008 (KR) 10-2008-0038330

(51) Int. Cl. H04J 15/00

(52) U.S. Cl. 370/312

(57) ABSTRACT

In a wireless mobile communications system, a network transmits a response request message with respect to a particular point-to-multipoint service to a terminal, the terminal transmits uplink access preamble according to information of the received response request message and receives a response message in response to the uplink access preamble. The terminal transmits an uplink message to a network if a terminal identifier together with an identifier of the preamble are included in the response message, and does not transmit the uplink message to the network if only the identifier of the preamble is included in the response message, thereby effectively utilizing uplink radio resources during the uplink access.

### CROSS REFERENCE TO RELATED APPLICATIONS

Pursuant to 35 U.S.C. §119, the present application claims the benefit of earlier filing date and right of priority to Provisional Application No. 60/915,666, filed May 2, 2007, and Korean application number 10-2008-0038330, filed Apr. 24, 2008, the contents of which are hereby incorporated by reference herein in their entirety.

### TECHNICAL FIELD

The present invention relates to a method for transmitting and receiving a point-to-multipoint service (e.g., Multimedia Broadcast Multicast Service (MBMS)) in an E-UMTS (Evolved Universal Mobile Telecommunications System) and, more particularly, a network transmits a response request message with respect to a particular point-to-multipoint service to a terminal, the terminal transmits uplink access preamble according to information of the received response request message and receives a response message in response to the uplink access preamble. The terminal transmits an uplink message to a network if a terminal identifier together with an identifier of the preamble are included in the response message, and does not transmit the uplink message to the network if only the identifier of the preamble is included in the response message, thereby effectively utilizing an uplink radio resources during the uplink access.

### RELATED ART

Universal mobile telecommunications system (UMTS) is a 3rd Generation (3G) asynchronous mobile communication system operating in wideband code division multiple access (WCDMA) based on European systems, global system for mobile communications (GSM) and general packet radio services (GPRS). The long-term evolution (LTE) of UMTS is under discussion by the 3rd generation partnership project (3GPP) that standardized UMTS.

The 3GPP LTE is a technology for enabling high-speed packet communications. Many schemes have been proposed for the LTE objective including those that aim to reduce user and provider costs, improve service quality, and expand and improve coverage and system capacity. The 3G LTE requires reduced cost per bit, increased service availability, flexible use of a frequency band, a simple structure, an open interface, and adequate power consumption of a terminal as an upper-level requirement.

FIG. 1 is a network structure of the E-UMTS, a mobile communication system applicable to the related art and the present invention.

With reference to FIG. 1, the E-UMTS network includes an E-UTRAN and an EPC (Evolved Packet Core). An interface between the E-UTRAN and the EPC can be used. An S1 interface can be used between the eNodeBs and the EPC. The eNodeBs are connected with each other through an X2 interface, and the X2 interface may be present between adjacent eNodeBs in a meshed network structure.

FIGS. 2 and 3 are block diagrams depicting the user-plane protocol and the control-plane protocol stack for the E-UMTS. As illustrated, the protocol layers may be divided into a first layer (L1), a second layer (L2) and a third layer (L3) based upon the three lower layers of an open system interconnection (OSI) standard model that is well known in the art of communication systems.

The physical layer, the first layer (L1), provides an information transmission service to an upper layer by using a physical channel. The physical layer is connected with a medium access control (MAC) layer located at a higher level through a transport channel, and data between the MAC layer and the physical layer is transferred via the transport channel. Between different physical layers, namely, between physical layers of a transmission side and a reception side, data is transferred via the physical channel.

The MAC layer of Layer 2 (L2) provides services to a radio link control (RLC) layer (which is a higher layer) via a logical channel. The RLC layer of Layer 2 (L2) supports the transmission of data with reliability. It should be noted that the RLC layer illustrated in FIGS. 2 and 3 is depicted because if the RLC functions are implemented in and performed by the MAC layer, the RLC layer itself is not required. The PDCP layer of Layer 2 (L2) performs a header compression function that reduces unnecessary control information such that data being transmitted by employing Internet protocol (IP) packets, such as IPv4 or IPv6, can be efficiently sent over a radio (wireless) interface that has a relatively small bandwidth.

A radio resource control (RRC) layer located at the lowest portion of the third layer (L3) is only defined in the control plane and controls logical channels, transport channels and the physical channels in relation to the establishment, reconfiguration, and release of the radio bearers (RBs). Here, the RB signifies a service provided by the second layer (L2) for data transmission between the terminal and the UTRAN.

As illustrated in FIG. 2, the RLC and MAC layers (terminated in an eNodeB 20 on the network side) may perform functions such as Scheduling, Automatic Repeat Request (ARQ), and Hybrid Automatic Repeat Request (HARQ). The PDCP layer (terminated in eNodeB 20 on the network side) may perform the user plane functions such as header compression, integrity protection, and ciphering.

As illustrated in FIG. 3, the RLC and MAC layers (terminated in an eNodeB 20 on the network side) perform the same functions as for the control plane. As illustrated, the RRC layer (terminated in an eNodeB 20 on the network side) may perform functions such as broadcasting, paging, RRC connection management, Radio Bearer (RB) control, mobility functions, and UE measurement reporting and controlling. The NAS control protocol (terminated in the MME of gateway 30 on the network side) may perform functions such as a SAE bearer management, authentication, LTE_IDLE mobility handling, paging origination in LTE_IDLE, and security control for the signaling between the gateway and UE 10.

The NAS control protocol may use three different states; first, a LTE_DETACHED state if there is no RRC entity; second, a LTE_IDLE state if there is no RRC connection while storing minimal UE information; and third, an LTE_ACTIVE state if the RRC connection is established. Also, the RRC state may be divided into two different states such as a RRC_IDLE and a RRC_CONNECTED.

In RRC_IDLE state, the UE 10 may receive broadcasts of system information and paging information while the UE specifies a Discontinuous Reception (DRX) configured by NAS, and the UE has been allocated an identification (ID) which uniquely identifies the UE in a tracking area. Also, in RRC-IDLE state, no RRC context is stored in the eNodeB.

In RRC_CONNECTED state, the UE 10 has an E-UTRAN RRC connection and a context in the E-UTRAN, such that transmitting and/or receiving data to/from the network (eNodeB) becomes possible. Also, the UE 10 can report channel quality information and feedback information to the eNodeB.

In RRC_CONNECTED state, the E-UTRAN knows the cell to which the UE 10 belongs. Therefore, the network can transmit and/or receive data to/from UE 10, the network can control mobility (handover) of the UE, and the network can perform cell measurements for a neighboring cell.

In RRC_IDLE mode, the UE 10 specifies the paging DRX (Discontinuous Reception) cycle. Specifically, the UE 10 monitors a paging signal at a specific paging occasion of every UE specific paging DRX cycle.

The paging occasion is a time interval during which a paging signal is transmitted. The UE 10 has its own paging occasion.

A paging message is transmitted over all cells belonging to the same tracking area. If the UE 10 moves from one tracking area to another tracking area, the UE will send a tracking area update message to the network to update its location.

A physical channel transfers signaling and data between layer L1 of a UE and eNB. As illustrated in FIG. 4, the physical channel transfers the signaling and data with radio resources, which consists of one or more sub-carriers in frequency and one more symbols in time.

One sub-frame, which is 1.0 ms. in length, consists of several symbols. The particular symbol(s) of the sub-frame, such as the first symbol of the sub-frame, can be used for the L1/L2 control channel. The L1/L2 control channel carries L1/L2 control information, such as signaling.

A transport channel transfers signaling and data between the L1 and MAC layers. A physical channel is mapped to a transport channel.

Downlink transport channel types include a Broadcast Channel (BCH), a Downlink Shared Channel (DL-SCH), a Paging Channel (PCH) and a Multicast Channel (MCH). The BCH is used for transmitting system information. The DL-SCH supports HARQ, dynamic link adaptation by varying the modulation, coding and transmit power, and both dynamic and semi-static resource allocation. The DL-SCH also may enable broadcast in the entire cell and the use of beamforming. The PCH is used for paging a UE. The MCH is used for multicast or broadcast service transmission.

Uplink transport channel types include an Uplink Shared Channel (UL-SCH) and Random Access Channel(s) (RACH). The UL-SCH supports HARQ and dynamic link adaptation by varying the transmit power and potentially modulation and coding. The UL-SCH also may enable the use of beamforming. The RACH is normally used for initial access to a cell.

The MAC sublayer provides data transfer services on logical channels. A set of logical channel types is defined for different data transfer services offered by MAC. Each logical channel type is defined according to the type of information transferred.

Logical channels are generally classified into two groups. The two groups are control channels for the transfer of control plane information and traffic channels for the transfer of user plane information.

Control channels are used for transfer of control plane information only. The control channels provided by MAC include a Broadcast Control Channel (BCCH), a Paging Control Channel (PCCH), a Common Control Channel (CCCH), a Multicast Control Channel (MCCH) and a Dedicated Control Channel (DCCH). The BCCH is a downlink channel for broadcasting system control information. The PCCH is a downlink channel that transfers paging information and is used when the network does not know the location cell of a UE. The CCCH is used by UEs having no RRC connection with the network. The MCCH is a point-to-multipoint downlink channel used for transmitting MBMS control information from the network to a UE. The DCCH is a point-to-point bi-directional channel used by UEs having an RRC connection that transmits dedicated control information between a UE and the network.

Traffic channels are used for the transfer of user plane information only. The traffic channels provided by MAC include a Dedicated Traffic Channel (DTCH) and a Multicast Traffic Channel (MTCH). The DTCH is a point-to-point channel, dedicated to one UE for the transfer of user information and can exist in both uplink and downlink. The MTCH is a point-to-multipoint downlink channel for transmitting traffic data from the network to the UE.

Uplink connections between logical channels and transport channels include a DCCH that can be mapped to UL-SCH and a DTCH that can be mapped to UL-SCH. Downlink connections between logical channels and transport channels include a BCCH that can be mapped to BCH, a PCCH that can be mapped to PCH, a DCCH that can be mapped to DL-SCH, and a DTCH that can be mapped to DL-SCH.

Usually, a network can perform a MBMS counting procedure if the network needs to know there is any existed terminal that receives a particular MBMS service in a particular cell or needs to count a number of terminals. Here, the MBMS counting procedure is referred that the processing steps of transmitting an access information message via a MCCH (Multicast Control Channel) by the network and transmitting a RRC connection setup message or a cell update message in response to the access information message by the terminal.

As discussed above, in conventional art, the network has to transmit an access information message to the terminal for the MBMS counting, and then the terminal must transmit a RRC connection request message or a cell update message in response to the access information message. However, in such circumstance, due to a size of the RRC connection request message or the cell update message, too much uplink radio resources are used for the MBMS counting, thereby causing a great drawback of ineffectively utilizing the uplink radio resources during the uplink access.

### SUMMARY

The present invention has been developed in order to solve the above described problems of the related art. As a result, the present invention may provide a method for transmitting and receiving a point-to-multipoint (e.g., MBMS service) while effectively utilizing uplink radio resources during the uplink access.

To implement at least the above feature in whole or in parts, the present invention may provide a method of receiving a point-to-multipoint service in a wireless communications system, the method comprising: receiving access information message for the point-to-multipoint service; transmitting a random access preamble after receiving the access information message; receiving random access response in response to the random access preamble; and determining whether or not to transmit a response message for the random access response based on information included in the received random access response.

The present invention may also provide a method of providing a point-to-multipoint service in a wireless communications system, the method comprising: transmitting access information message for the point-to-multipoint service; receiving a random access preamble after the access information message is transmitted; and transmitting random access response in response to the received random access preamble, wherein information included in the random access response is used by a terminal for determining whether or not to transmit a response message to a network.

The present invention may also provide a mobile terminal for receiving a point-to-multipoint service in a wireless communication system, the mobile terminal comprising: a transceiver adapted to transmit or receive the point-to-multipoint service; a memory adapted to store the point-to-multipoint service data transmitted or received via the transceiver or from an external source; and a processor cooperating with the transceiver and the memory and adapted to perform the steps of, receiving access information message for the point-to-multipoint service; transmitting a random access preamble after receiving the access information message; receiving random access response in response to the random access preamble; and determining whether or not to transmit a response message for the random access response based on information included in the received random access response.

Additional features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

### BRIEF DESCRIPTION OF THE DRAWINGS

FIG. 1 shows an exemplary network structure of the E-UMTS.

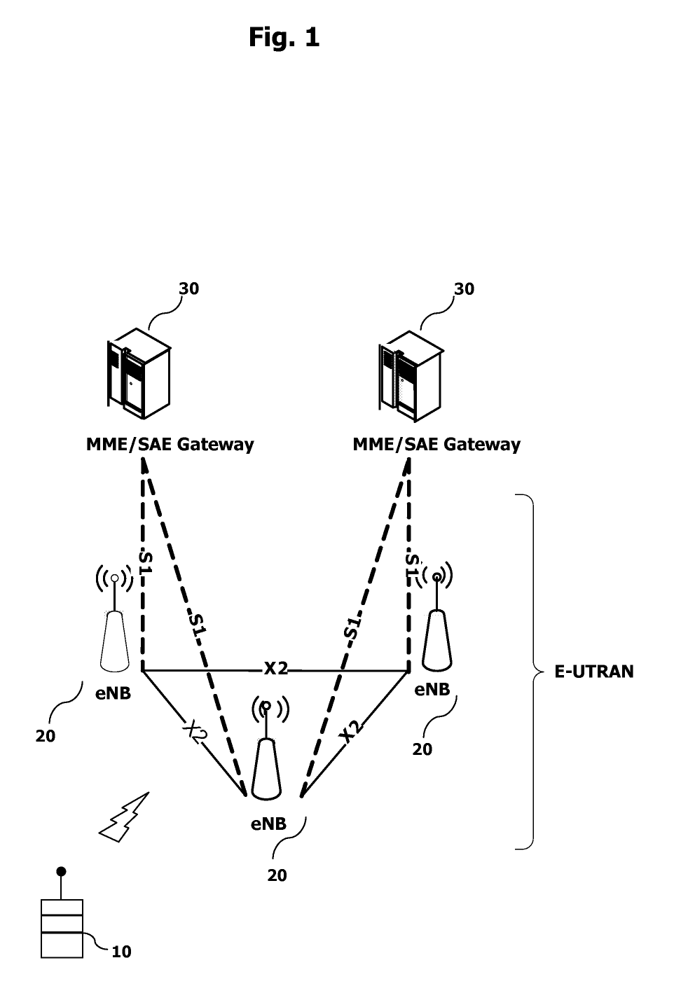

FIG. 2 shows an exemplary user-plane protocol stack for the E-UMTS.

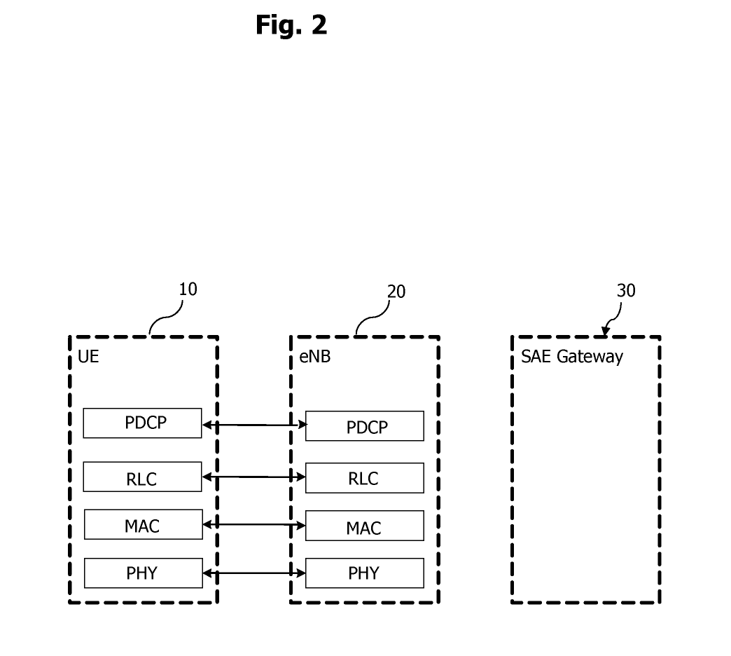

FIG. 3 shows an exemplary control-plane protocol stack for the E-UMTS.

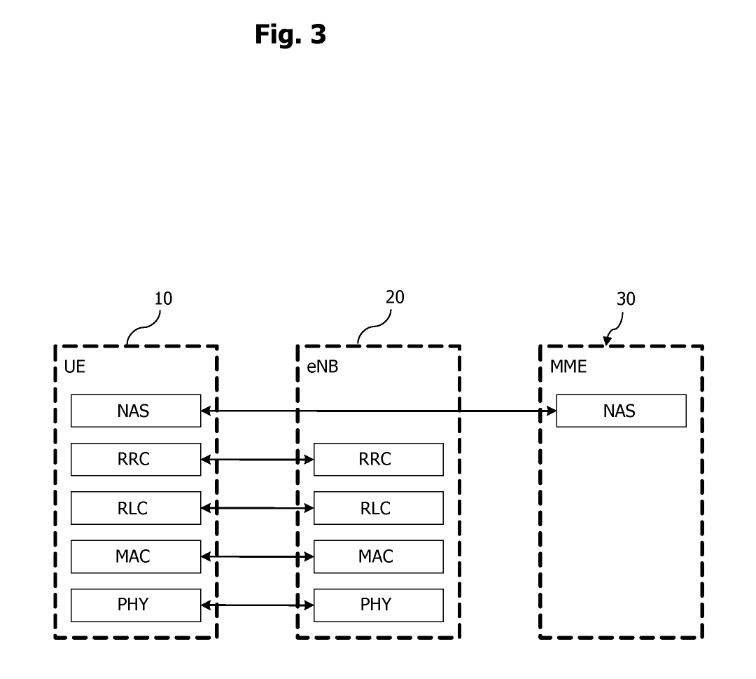

FIG. 4 shows an exemplary structure of the physical channel.

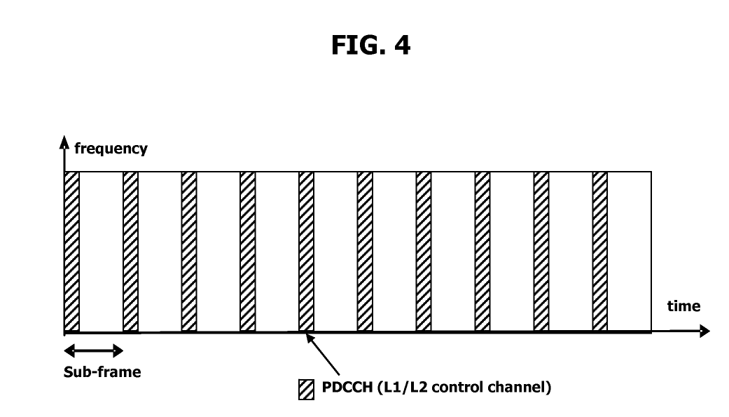

FIG. 5 shows an exemplary diagram illustrating a MBMS counting procedure in accordance with the present invention.

### DESCRIPTION

One aspect of the present invention is the recognition by the present inventors regarding the problems and drawbacks of the related art described above and explained in more detail hereafter. Based upon such recognition, the features of the present invention have been developed.

Although the present invention is shown to be implemented in a mobile communication system, such as a UMTS and E-UMTS developed under 3GPP specifications, the present invention can also be applied to other communication systems operating in conformity with different standards and specifications.

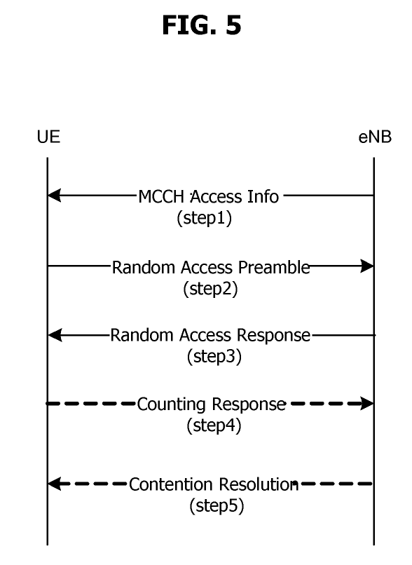

According to the present invention, the wireless network may perform the counting procedure for the particular MBMS service. FIG. 5 shows an exemplary diagram illustrating a MBMS counting procedure in accordance with the present invention.

In order to begin the counting procedure with respect to a particular MBMS service, the network (i.e., eNB) may transmit an access information message via a MCCH (Multicast Control Channel). (Step 1) Here, the access information message may be a RRC message or a MAC control PDU (Protocol Data Unit) that is generated in a MAC layer, and the access information message may include a preamble set or a particular preamble for the particular MBMS service.

The eNB also may transmit the access information message via a PDCCH (Physical Downlink Control Channel). In this case, the PDCCH may transmit an identifier of the MBMS service or an indicator for performing the MBMS counting procedure. After a terminal receives the access information message, in order to perform an uplink access procedure for receiving the particular MBMS service, the terminal may transmit one of preambles (or a service dedicated signature) that were included in a preamble set. (Step 2) Here, the preamble set may be included in or allocated by the access information message. Also, the terminal may transmit a terminal dedicated preamble (or UE dedicated signature) that was previously allocated or selected by eNB. If the terminal has the terminal dedicated preamble previously allocated by the eNB, the terminal may transmit such terminal dedicated preamble to the eNB rather than transmitting the one of preambles included in the preamble set such that a transmission of a contention resolution message may not be necessary.

After receiving such preamble, the eNB may transmit a random access response to the terminal. (Step 3) Here, the random access response may include an identifier of the preamble, timing adjustment information, newly allocated C-RNTI (Cell-Radio Network Temporary Identity) or uplink radio resource allocation information.

After the reception of the random access response by the terminal, if the random access response includes an identifier of the preamble transmitted from the terminal and the newly allocated C-RNTI, the terminal may transmit a counting response message based on the uplink radio resource allocation information (Step 4). Here, the counting response message may include a terminal identifier as well as an identifier of the particular MBMS service. The counting response message may transmit via a RRC message or a MAC control PDU. After the counting response message is received by the eNB, the eNB may count such terminal as a terminal receiving the particular MBMS service according the counting response message.

After the reception of the random access response by the terminal, if the random access response includes the identifier of the preamble transmitted from the terminal but not includes the newly allocated C-RNTI or the uplink radio resource allocation information, the terminal may not transmit the counting response message to the eNB. In this case, although the counting response message may not be transmitted to the eNB, the eNB may count such terminal as a terminal receiving the particular MBMS service according to the reception of the preamble.

Namely, if there is no allocated C-RNTI in the random access response received after sending the random access preamble with a MBMS dedicated signature, the terminal (i.e., MBMS UE) may decide not to transmit the counting response message. However, if there is an allocated C-RNTI in the random access response received after sending the random access preamble with the MBMS dedicated signature, the terminal (i.e., MBMS UE) may decide to transmit the counting response message. Here, a contention may be occurred between MBMS UEs that have activated the same MBMS service if the preamble was allocated or included in the access information message. Therefore, after successfully transmitting the counting response message by the terminal, the eNB may transmit a contention resolution message to the terminal (Step 5). Here, the contention resolution message may be transmitted via the RRC message, the MAC control PDU, or the PDCCH. Also, the contention resolution message may include the terminal identifier as well as the identifier of the particular MBMS service.

The present invention may provide a method of receiving a point-to-multipoint service in a wireless communications system, the method comprising: receiving access information message for the point-to-multipoint service; transmitting a random access preamble after receiving the access information message; receiving random access response in response to the random access preamble; determining whether or not to transmit a response message for the random access response based on information included in the received random access response; and receiving a contention resolution message in response to the counting response message., wherein the point-to-multipoint service is a MBMS (Multimedia Broadcast/Multicast Service) service and the access information message is a MBMS access information message including a MBMS service identifier (MBMS service ID), the access information message is received via a MCCH (Multicast Control Channel), the random access preamble is one of preambles included in the access information message and is a terminal dedicated preamble allocated previously by a network, the random access preamble is transmitted through a RACH (Random Access Channel), the random access response includes at least one of a preamble identifier, timing adjustment information, newly allocated C-RNTI (Control-Radio Network Temporary Identities) and uplink radio resource allocation information, the response message is transmitted to a network if the random access response includes the preamble identifier and the newly allocated C-RNTI, the response message is not transmitted to a network if the random access response does not include the newly allocated C-RNTI and/or the uplink radio resource allocation information, the response message is a counting response message according to the uplink radio resource allocation information, the counting response message includes the newly allocated C-RNTI and/or a MBMS service identifier (MBMS service ID) and is transmitted via a RRC message or a MAC control PDU (Protocol Data Unit), and the contention resolution message includes the newly allocated C-RNTI and/or a MBMS service identifier (MBMS service ID) and is received via a RRC message, a MAC control PDU, or a PDCCH (Physical Downlink Control Channel).

It can be said that the present invention may provide a method of providing a point-to-multipoint service in a wireless communications system, the method comprising: transmitting access information message for the point-to-multipoint service; receiving a random access preamble after the access information message is transmitted; transmitting random access response in response to the received random access preamble; counting a number of terminals receiving the point-to-multipoint service according to the counting response message; and transmitting a contention resolution message in response to the counting response message, wherein information included in the random access response is used by a terminal for determining whether or not to transmit a response message to a network, the point-to-multipoint service is a MBMS (Multimedia Broadcast/Multicast Service) service and the access information message is a MBMS access information message including a MBMS service identifier (MBMS service ID), the access information message is transmitted through a MCCH (Multicast Control Channel), the random access response includes at least one of a preamble identifier, timing adjustment information, newly allocated C-RNTI (Control-Radio Network Temporary Identities) and uplink radio resource allocation information, the terminal transmits the response message to a network if the random access response includes the preamble identifier and the newly allocated C-RNTI, the terminal does not transmit the response message to a network if the random access response does not include the newly allocated C-RNTI and/or the uplink radio resource allocation information, the response message is a counting response message according to the uplink radio resource allocation information, the counting response message includes the newly allocated C-RNTI and/or a MBMS service identifier (MBMS service ID), the contention resolution message includes the newly allocated C-RNTI and/or a MBMS service identifier (MBMS service ID), the counting response message is received via a RRC message or a MAC control PDU (Protocol Data Unit) and the contention resolution message is transmitted through the RRC message, the MAC control PDU, or a PDCCH (Physical Downlink Control Channel).

It can be also said that the present invention may provide a mobile terminal for receiving a point-to-multipoint service in a wireless communication system, the mobile terminal comprising: a transceiver adapted to transmit or receive the point-to-multipoint service; a memory adapted to store the point-to-multipoint service data transmitted or received via the transceiver or from an external source; and a processor cooperating with the transceiver and the memory and adapted to perform the steps of, receiving access information message for the point-to-multipoint service; transmitting a random access preamble after receiving the access information message; receiving random access response in response to the random access preamble; and determining whether or not to transmit a response message for the random access response based on information included in the received random access response.

Although the present invention is described in the context of mobile communications, the present invention may also be used in any wireless communication systems using mobile devices, such as PDAs and laptop computers equipped with wireless communication capabilities (i.e. interface). Moreover, the use of certain terms to describe the present invention is not intended to limit the scope of the present invention to a certain type of wireless communication system. The present invention is also applicable to other wireless communication systems using different air interfaces and/or physical layers, for example, TDMA, CDMA, FDMA, WCDMA, OFDM, EV-DO, Wi-Max, Wi-Bro, etc.

The exemplary embodiments may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Field Programmable Gate Array (FPGA), Application Specific Integrated Circuit (ASIC), etc.) or a computer readable medium (e.g., magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.).

Code in the computer readable medium may be accessed and executed by a processor. The code in which exemplary embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

1. A method of receiving a point-to-multipoint service in a wireless communications system, the method comprising:
receiving access information message for the point-to-multipoint service;
transmitting a random access preamble after receiving the access information message;
receiving random access response in response to the random access preamble; and
determining whether or not to transmit a response message for the random access response based on information included in the received random access response.

2. The method of claim 1, wherein the point-to-multipoint service is a MBMS (Multimedia Broadcast/Multicast Service) service and the access information message is a MBMS access information message including a MBMS service identifier (MBMS service ID).

3. The method of claim 1, wherein the random access preamble is one of preambles included in the access information message.

4. The method of claim 1, wherein the random access preamble is a terminal dedicated preamble allocated previously by a network.

5. The method of claim 1, wherein the random access response includes at least one of a preamble identifier, timing adjustment information, newly allocated C-RNTI (Cell-Radio Network Temporary Identities) and uplink radio resource allocation information.

6. The method of claim 5, wherein the response message is transmitted to a network if the random access response includes the preamble identifier and the newly allocated C-RNTI.

7. The method of claim 5, wherein the response message is not transmitted to a network if the random access response does not include the newly allocated C-RNTI.

8. The method of claim 6, wherein the response message is a counting response message according to the uplink radio resource allocation information.

9. The method of claim 8, wherein the counting response message includes the newly allocated C-RNTI and/or a MBMS service identifier (MBMS service ID).

10. The method of claim 8, further comprising:
receiving a contention resolution message in response to the counting response message.

11. The method of claim 10, wherein the contention resolution message includes the newly allocated C-RNTI and/or a MBMS service identifier (MBMS service ID).

12. The method of claim 11, wherein the contention resolution message is received via a RRC message, a MAC control PDU, or a PDCCH (Physical Downlink Control Channel).

13. A method of providing a point-to-multipoint service in a wireless communications system, the method comprising:
transmitting access information message for the point-to-multipoint service;
receiving a random access preamble after the access information message is transmitted; and
transmitting random access response in response to the received random access preamble,
wherein information included in the random access response is used by a terminal for determining whether or not to transmit a response message to a network.

14. The method of claim 13, wherein the point-to-multipoint service is a MBMS (Multimedia Broadcast/Multicast Service) service and the access information message is a MBMS access information message including a MBMS service identifier (MBMS service ID).

15. The method of claim 13, wherein the random access response includes at least one of a preamble identifier, timing adjustment information, newly allocated C-RNTI (Cell-Radio Network Temporary Identities) and uplink radio resource allocation information.

16. The method of claim 15, wherein the response message is received from a terminal if the random access response includes the preamble identifier and the newly allocated C-RNTI.

17. The method of claim 16, wherein the response message is a counting response message according to the uplink radio resource allocation information.

18. The method of claim 17, wherein the counting response message includes the newly allocated C-RNTI and/or a MBMS service identifier (MBMS service ID).

19. The method of claim 17, further comprising:
transmitting a contention resolution message in response to the counting response message.

20. The method of claim 19, wherein the contention resolution message includes the newly allocated C-RNTI and/or a MBMS service identifier (MBMS service ID).

21. The method of claim 20, wherein the counting response message is received via a RRC message or a MAC control PDU (Protocol Data Unit) and the contention resolution message is transmitted through the RRC message, the MAC control PDU, or a PDCCH (Physical Downlink Control Channel).
